(19) United States
(12) Patent Application Publication
(10) Pub. No.: US 2017/0069138 A1
(43) Pub. Date: Mar. 9, 2017

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Shinichi Aratani, Kawasaki-shi (JP)

(21) Appl. No.: 15/255,784

(22) Filed: Sep. 2, 2016

(30) Foreign Application Priority Data
Sep. 9, 2015 (JP) 2015-177917
May 27, 2016 (JP) 2016-106717

(51) Int. Cl. G06T 19/00; G06K 9/00; G06K 9/78; G06T 7/00

(52) U.S. Cl. CPC G06T 19/006; G06T 7/0042; G06K 9/00577; G06K 9/78; G06F 3/0482

(57) ABSTRACT

An information processing apparatus for determining feature information that is to be used to estimate a position and an orientation of a camera, the information processing apparatus comprising: a holding unit configured to hold environment information regarding a physical space, and feature information corresponding to the environment information regarding the physical space, in association with each other; an acquisition unit configured to acquire environment information regarding a physical space in which mixed reality is to be experienced; and a determination unit configured to determine feature information that is to be placed in the physical space in which mixed reality is to be experienced, based on the environment information acquired by the acquisition unit.

### BACKGROUND OF THE INVENTION

Field of the Invention

The present invention relates to an information processing apparatus, a method for controlling the information processing apparatus, and a storage medium.

Description of the Related Art

Mixed reality (MR) technology and augmented reality (AR) technology are known as technologies for fusing the physical world and the virtual world together in real time. These technologies seamlessly fuse a physical space, and a virtual space created by a computer, together. A video see-through type head mounted display (HMD) or the like is used as an apparatus that allows an observer to feel as if a virtual object actually exists in a physical space.

In the case of MR using a video see-through type HMD, every time an image is input from a built-in camera of the HMD, the position and the orientation of the camera in the physical space at the time of capturing an image are measured. Typically, a computer graphic (CG) is rendered based on the position and the orientation of the camera and unique parameters of the camera such as a focal point distance, and the CG is superimposed on an image in the physical space. In such a case, in order to allow the user to feel as if the virtual object actually exists in the physical space, it is necessary for the virtual object and the physical space to be geometrically consistent, and hence positioning is required. The problem with positioning is a problem with measuring the position and the orientation of the built-in camera of the HMD in the physical space.

The position and the orientation of the camera can be measured by using a physical sensor having six degrees of freedom, such as a magnetic sensor, an ultrasound sensor, or an optical sensor. In the case of using a video see-through type HMD, it is possible to use image information (e.g. natural features such as edges and luminance gradients) received from the built-in camera of the video see-through type HMD to perform positioning. According to “Klein, G., Murray, D.: Parallel tracking and mapping for small AR workspaces. In: Intl. Symp. on Mixed and Augmented Reality (ISMAR), 2007”, feature points are detected from an image as natural features, and the position and the orientation of the camera are estimated by using the feature points.

However, according to the technology disclosed in “Klein, G., Murray, D.: Parallel tracking and mapping for small AR workspaces. In: Intl. Symp. on Mixed and Augmented Reality (ISMAR), 2007”, it is presumed that a large number of natural features can be detected on the image in order to estimate the position and the orientation of the camera. For example, in the case of capturing an image, with a camera, of a wall that has no pattern, there is a problem in that it is impossible to estimate the position and the orientation of the camera if the appropriate natural features cannot be detected within the field of view.

Also, natural features to be used, such as salient points, edges, and luminance gradients, vary depending on the method adopted to estimate the position and the orientation of the camera. Therefore, there is a problem in that users who do not have background knowledge regarding the method for estimating the position and the orientation of a camera cannot tell natural features that are suitable for reliably estimating the position and the orientation of the camera.

In view of the above-described problems, the present invention provides a technology for providing information regarding natural features that are suitable for estimating the position and the orientation of a camera.

### SUMMARY OF THE INVENTION

According to one aspect of the present invention, there is provided an information processing apparatus for determining feature information that is to be used to estimate a position and an orientation of a camera, the information processing apparatus comprising: a holding unit configured to hold environment information regarding a physical space, and feature information corresponding to the environment information regarding the physical space, in association with each other; an acquisition unit configured to acquire environment information regarding a physical space in which mixed reality is to be experienced; and a determination unit configured to determine feature information that is to be placed in the physical space in which mixed reality is to be experienced, based on the environment information acquired by the acquisition unit.

Further features of the present invention will become apparent from the following description of exemplary embodiments with reference to the attached drawings.

### BRIEF DESCRIPTION OF THE DRAWINGS

FIG. 1 is a diagram showing an example of a configuration of an information processing apparatus according to a first embodiment.

FIG. 2 is a diagram showing an example of feature information according to the first embodiment.

FIG. 3 is a diagram showing a data structure of mixed reality experiential environment information and feature information according to the first embodiment.

FIG. 4 is a flowchart showing processing procedures performed by the information processing apparatus according to the first embodiment.

FIG. 5 is a diagram showing an example of a configuration of an information processing apparatus according to a second embodiment.

FIG. 6 is a flowchart showing processing procedures according to the second embodiment by which the information processing apparatus determines a piece of mixed reality experiential environment information.

FIG. 7 is a block diagram showing an example of a hardware configuration according to an embodiment of the present invention.

FIG. 8 is a diagram showing an example of a configuration of an information processing apparatus according to a third embodiment.

FIG. 9 is a flowchart showing processing procedures performed by the information processing apparatus according to the third embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

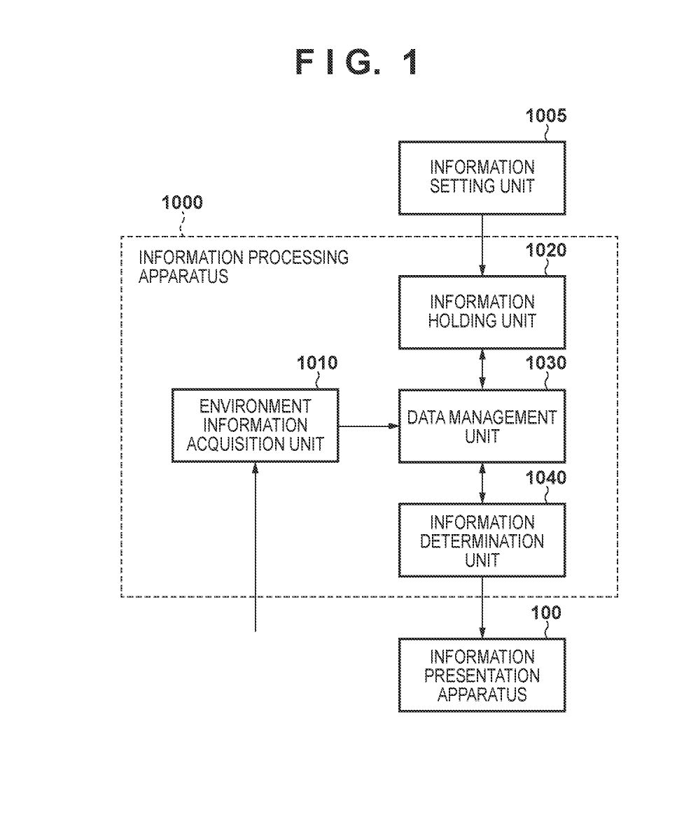

In the first embodiment, a description is given of an example in which, in order to provide a mixed reality experience, a feature object that is suitable for estimating the position and the orientation of a camera using natural features is determined according to the environment in which mixed reality is to be experienced. FIG. 1 is a diagram showing an example of a configuration of an information processing apparatus 1000 according to the present embodiment. The information processing apparatus 1000 includes an environment information acquisition unit 1010, an information holding unit 1020, a data management unit 1030, and an information determination unit 1040. The information processing apparatus 1000 is connected to an information setting unit 1005 and an information presentation apparatus 100.

The information processing apparatus 1000 performs processing to determine feature information that is suitable for estimating the position and the orientation of a camera using natural features, based on: mixed reality experiential environment information (environment information regarding an environment in which mixed reality is to be experienced) acquired by the environment information acquisition unit 1010; and feature information held by the information holding unit 1020. The following describes the operation of each processing unit in detail.

The environment information acquisition unit 1010 acquires mixed reality experiential environment information. The environment information acquisition unit 1010 acquires a piece of mixed reality experiential environment information upon a user selecting the piece of experiential environment information from a list of pieces of experiential environment information, which is displayed on a GUI, by using a mouse, for example.

Here, a description is given of mixed reality experiential environment information. Mixed reality experiential environment information is information regarding an environment in which mixed reality is to be experienced, and is, for example, category information regarding a location in which mixed reality is to be experienced.

For example, when a design review is to be carried out in the design/manufacturing field by using a mixed reality system, the review is carried out in a meeting room where a large monitor or screen, desks, chairs, and so on are placed. When mixed reality is to be experienced in an environment in which these objects exist, the category information regarding the location, which is the experiential environment information regarding the mixed reality, is set to indicate “meeting room”.

In the field of architecture, when a review of a design image of a building that is to be built or under construction is to be carried out by using a mixed reality system, the review is carried out at a construction site where construction machines and signs indicating that construction is in progress are placed. When mixed reality is to be experienced in an environment in which these objects exist, the category information regarding the location, which is the experiential environment information regarding the mixed reality, is set to indicate “construction site”.

When a review of the introduction of a manufacturing machine is to be carried out in the manufacturing field by using a mixed reality system, the review is carried out in a factory where existing manufacturing apparatuses, parts racks, assembly robots, adjustment tools, and so on are placed. When mixed reality is to be experienced in an environment in which these objects exist, the category information regarding the location, which is the experiential environment information regarding the mixed reality, is set to indicate “factory”. Mixed reality experiential environment information is not limited to the above-described examples, and may be any kind of mixed reality experiential environment information, insofar as the experiential environment information is category information that is set based on the location in which mixed reality is to be experienced.

The information holding unit 1020 holds pieces of feature information used to estimate the position and the orientation of the camera. The pieces of feature information are associated with pieces of environment information regarding the environment in which mixed reality is to be experienced. Here, a description is given of pieces of feature information. Feature information is information for which it has been confirmed in advance that natural features that are required for estimating the position and the orientation of the camera can be sufficiently and reliably detected from it. In the present embodiment, pieces of feature information are pieces of image information each having a feature pattern that is printable, for example.

The data management unit 1030 manages pieces of mixed reality experiential environment information, acquired by the environment information acquisition unit 1010, and pieces of feature information held by the information holding unit 1020. The data management unit 1030 outputs pieces of mixed reality experiential environment information, acquired by the environment information acquisition unit 1010, to the information determination unit 1040. Also, in response to a request from the information determination unit 1040, the data management unit 1030 acquires pieces of feature information corresponding to a piece of mixed reality experiential environment information, from the information holding unit 1020, and outputs the pieces of feature information to the information determination unit 1040. The information determination unit 1040 determines a piece of feature information based on the information acquired from the data management unit 1030.

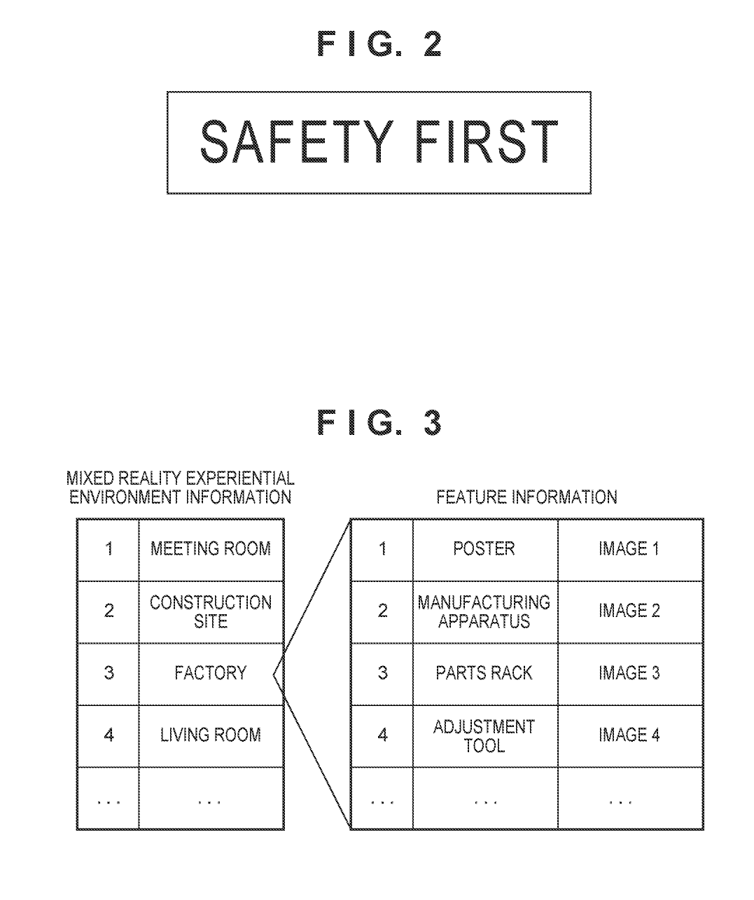

Here, the information setting unit 1005 performs processing to associate the pieces of mixed reality experiential environment information, which are pieces of category information regarding the location in which mixed reality is to be experienced, and pieces of feature information, with each other, in response to a user operation, and to preliminarily set the pieces of information that have been associated with each other. Here, FIG. 2 shows an example of a piece of feature information according to the present embodiment. FIG. 3 is a diagram showing a data structure of pieces of mixed reality experiential environment information and pieces of feature information according to the present embodiment. For example, in the case where a piece of mixed reality experiential environment information indicates “factory”, if natural features of a poster showing a motto such as “safety first” as shown in FIG. 2 can be sufficiently and reliably detected, an image of such a poster is set as an image 1 as shown in FIG. 3.

This setting is manually performed by the user selecting a piece of category information and an image having a feature pattern, using a mouse. Combinations of pieces of category information and pieces of feature information are preliminarily set before the information processing apparatus 1000 starts operating, using feature objects that are typical of the location in which mixed reality is to be experienced and that do not seem out of place, based on the user's knowledge. The pieces of information that have been set by the information setting unit 1005 are stored in a storage medium drive such as a hard disk, which is not shown in the drawings, and is read out by a CPU, which is not shown in the drawings. The information presentation apparatus 100 is a display, and presents a piece of feature information that has been determined by the information determination unit 1040. The presentation of the feature information may be performed by displaying or projecting the piece of feature information.

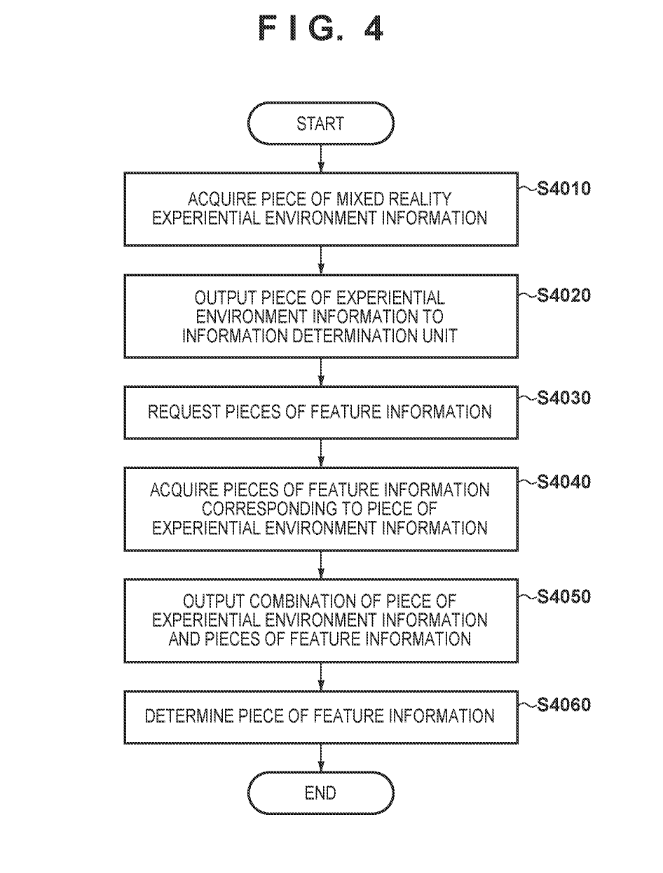

FIG. 4 is a flowchart showing processing procedures performed by the information processing apparatus according to the present embodiment. More specifically, FIG. 4 shows processing procedures by which, in order to provide a mixed reality experience, feature information that is suitable for estimating the position and the orientation of the camera by using natural features is determined according to the environment in which mixed reality is to be experienced. Note that a program code that follows the flowchart is stored in a memory within the information processing apparatus according to the present embodiment, such as a RAM or a ROM, which are not shown in the drawings, and is read out and executed by a CPU, which is not shown in the drawings.

In step S4010, the environment information acquisition unit 1010 acquires a piece of mixed reality experiential environment information, and outputs the piece of experiential environment information to the data management unit 1030. In the present embodiment, the environment information acquisition unit 1010 acquires a piece of mixed reality experiential environment information upon a user selecting the piece of experiential environment information from a list of pieces of experiential environment information, which are displayed on a GUI, by using a mouse, for example.

In step S4020, the data management unit 1030 outputs the piece of experiential environment information regarding the mixed reality, acquired by the environment information acquisition unit 1010, to the information determination unit 1040. In step S4030, the information determination unit 1040 requests the data management unit 1030 for pieces of feature information corresponding to the piece of mixed reality experiential environment information.

In step S4040, the data management unit 1030 outputs the piece of mixed reality experiential environment information to the information holding unit 1020, and acquires the pieces of feature information that are associated with the piece of mixed reality experiential environment information and that are held by the information holding unit 1020, from the information holding unit 1020.

In step S4050, the data management unit 1030 outputs the combination of the piece of mixed reality experiential environment information and the pieces of feature information to the information determination unit 1040. In step S4060, the information determination unit 1040 determines a piece of feature information corresponding to the piece of mixed reality experiential environment information, as a desired piece of feature information. Note that if there are pieces of feature information corresponding to the piece of mixed reality experiential environment information, a piece of feature information may be determined in response to a user operation to select a desired piece of feature information.

By performing the above-described processing, it is possible to determine an image having a feature pattern corresponding to a piece of mixed reality experiential environment information, as a piece of feature information.

Then, the piece of feature information thus determined is displayed on the information presentation apparatus 100, which is a display or the like, the image having a feature pattern displayed on the display is printed out, and is actually placed in the environment in which mixed reality is to be experienced. It is possible to produce a stable mixed reality by detecting features from an image of the placed feature object captured using the camera, and estimating the position and the orientation of the camera based on natural features. Also, it is possible to produce a strong sense of immersion because a feature object that is familiar to the user and that does not seem out of place is placed in the location in which mixed reality is to be experienced.

First Modification

In the first embodiment, mixed reality experiential environment information is category information regarding the location. However, mixed reality experiential environment information is not limited to category information, and may be information regarding the types of natural features used to estimate the position and the orientation of the camera. Natural features to be used, such as salient points, edges, and luminance gradients, vary depending on the method adopted to estimate the position and the orientation of the camera. Therefore, it is desirable to set feature information with consideration of what natural feature is suitable for reliably estimating the position and the orientation of the camera.

The environment information acquisition unit 1010 acquires information regarding the types of natural features that are to be used to estimate the position and the orientation of the camera. The environment information acquisition unit 1010 outputs the acquired information regarding the types of natural features that are to be used to estimate the position and the orientation of the camera, to the data management unit 1030. For example, in the case of estimating the position and the orientation of the camera by performing salient point detection, “salient point”, which is a type of natural feature, is set as a piece of mixed reality experiential environment information. A feature pattern from which a salient point can be reliably detected may be set as a piece of feature information in association with “salient point”, which is a piece of mixed reality experiential environment information.

In this way, pieces of information regarding the types of natural features used to estimate the position and the orientation of the camera are preliminarily set in association with pieces of feature information, and a piece of feature information is determined by acquiring a piece of information regarding a type of natural feature as a piece of mixed reality experiential environment information. This configuration makes it possible to determine a feature object from which natural features can be reliably detected, without the user knowing an algorithm regarding what shape can be reliably detected as a natural feature.

Second Modification

In the first embodiment, pieces of feature information are images each having a feature pattern that is printable. However, pieces of feature information are not limited to such images, insofar as it is possible to determine an object from which natural features can be detected. For example, if a piece of mixed reality experiential environment information indicates a location category “meeting room”, it is possible to use the features of objects such as chairs and desks. Therefore, these pieces of three-dimensional model information may be determined as pieces of feature information.

By determining a piece of three-dimensional model information of an object as a piece of feature information, and presenting the piece of three-dimensional model information to the user of the mixed reality, it is possible to inform the user, who does not have background knowledge, of what kind of object can be added to the environment as an object from which natural features can be reliably detected.

Third Modification

In the first embodiment, pieces of feature information are images each having a feature pattern that is printable. In the second modification, it was stated that pieces of three-dimensional model information may be used as pieces of feature information. However, pieces of feature information are not limited to pieces of three-dimensional model information, insofar as it is possible to determine an object from which natural features can be detected. For example, if a piece of mixed reality experiential environment information indicates a location category “meeting room”, it is possible to use the features of objects such as chairs and desks. Therefore, pieces of object name information may be determined as pieces of feature information.

By determining a piece of object name information as a piece of feature information, and presenting the piece of object name information to the user, it is possible to inform the user, who does not have background knowledge, of what kind of object should be added to the environment as an object from which natural features can be reliably detected.

Fourth Modification

In the first embodiment, pieces of feature information are images each having a feature pattern that is printable. In the second modification, it was stated that pieces of three-dimensional model information may be used as pieces of feature information. In the third modification, it was stated that pieces of object name information may be used as pieces of feature information. However, pieces of feature information are not limited to pieces of object name information, insofar as it is possible to determine an object from which natural features can be detected. Pieces of feature information may be represented as three-dimensional objects. For example, three-dimensional objects generated by a 3D printer, which is an apparatus that outputs three-dimensional models, may be adopted.

If pieces of feature information are represented as three-dimensional objects, the information presentation apparatus 100 presents the piece of feature information that has been determined. In this regard, the information presentation apparatus 100 may be a light that is assigned to each three-dimensional object and that can be subjected to illumination control. The piece of feature information may be presented by illuminating a light that is attached to a three-dimensional object that has been determined as the feature information, and that can be subjected to illumination control. By determining a three-dimensional object as a piece of feature information, and presenting the three-dimensional object to the user of the mixed reality, it is possible to inform the user, who does not have background knowledge, of what kind of object should be added to the environment as an object from which natural features can be reliably detected.

Fifth Modification

In the first embodiment, a piece of feature information is displayed by the information presentation apparatus 100, which is a display or the like. The piece of feature information is image data having a feature pattern, and is printed out and placed. However, the information presentation apparatus 100 is not limited to a display.

For example, a piece of feature information may be projected by a projector that is fixed in the environment in which mixed reality is to be experienced. It is possible to reliably estimate the position and the orientation of the camera by detecting the feature pattern thus projected.

Sixth Modification

In the first embodiment, an image having a feature pattern is used as a piece of feature information, and the image is set to be associated with a piece of mixed reality experiential environment information by selecting the image, using a mouse. However, an image having a feature pattern, which is a piece of feature information, may be searched for on the Internet by using a piece of mixed reality experiential environment information as a keyword, and automatically set. In this case, it is assumed that the information setting unit 1005 is connected to the Internet, and is capable of performing a search.

It is possible to easily set a piece of feature information by searching for an image having a feature pattern, which is a piece of feature information, on the Internet, and setting the image, even if the number of pieces of mixed reality experiential environment information is increased.

### Second Embodiment

In the first embodiment, a description has been given of an example in which the user determines a piece of mixed reality experiential environment information by selecting the piece of experiential environment information from a list of pieces of mixed reality experiential environment information, which is displayed on a GUI, by using a mouse. However, a piece of mixed reality experiential environment information may be determined by identifying the environment in which mixed reality is to be experienced, based on an object detected from a captured image as a result of object recognition.

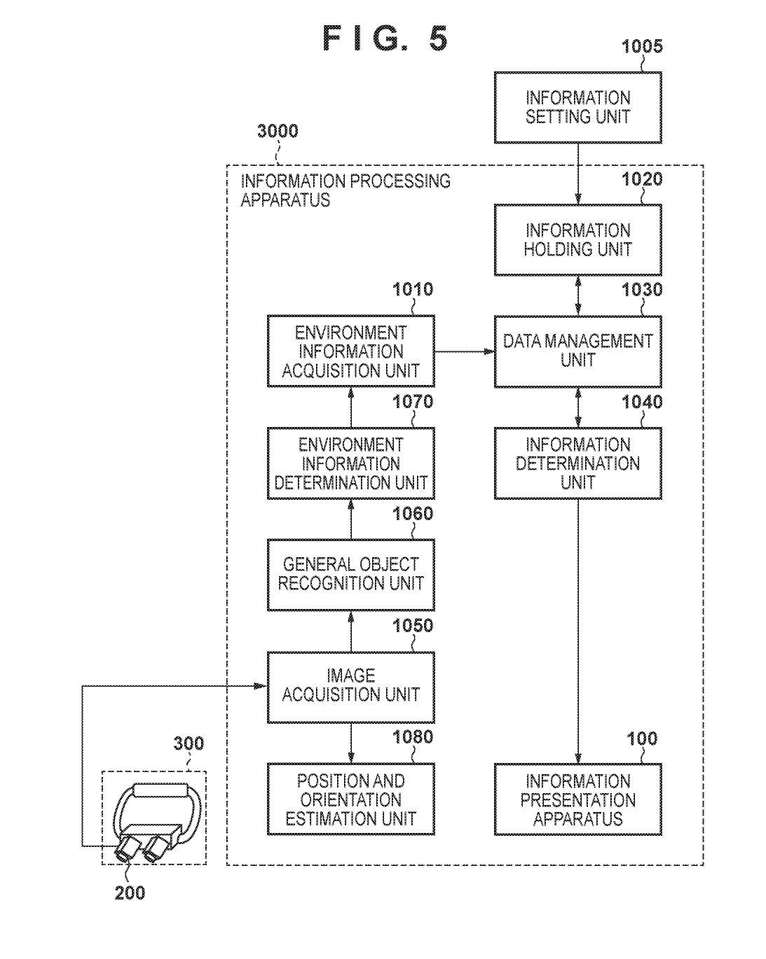

FIG. 5 is a diagram showing an example of a configuration of an information processing apparatus 3000 according to a second embodiment. The information processing apparatus 3000 includes, as in the first embodiment, the environment information acquisition unit 1010, the information holding unit 1020, the data management unit 1030, and the information determination unit 1040. The information processing apparatus 3000 further includes the information presentation apparatus 100, an image acquisition unit 1050, a general object recognition unit 1060, an environment information determination unit 1070, and a position and orientation estimation unit 1080.

Also, a camera 200 mounted on a head mounted display (HMD) 300 is connected to the image acquisition unit 1050. The information setting unit 1005 is, as in the first embodiment, connected to the information holding unit 1020.

The following mainly describes points of the present embodiment that are different from those of the first embodiment. The image acquisition unit 1050 inputs an image captured by the camera 200 to the information processing apparatus 3000. If the output of the camera 200 is a digital output such as an IEEE 1394 output, the image acquisition unit 1050 is realized with, for example, an IEEE 1394 interface board. If the output of the camera 200 is an analogue output such as an NTSC signal, the image acquisition unit 1050 is realized with, for example, an analogue video capture board. The image acquisition unit 1050 may read out digital data of still images and moving images that have been stored in a storage apparatus in advance.

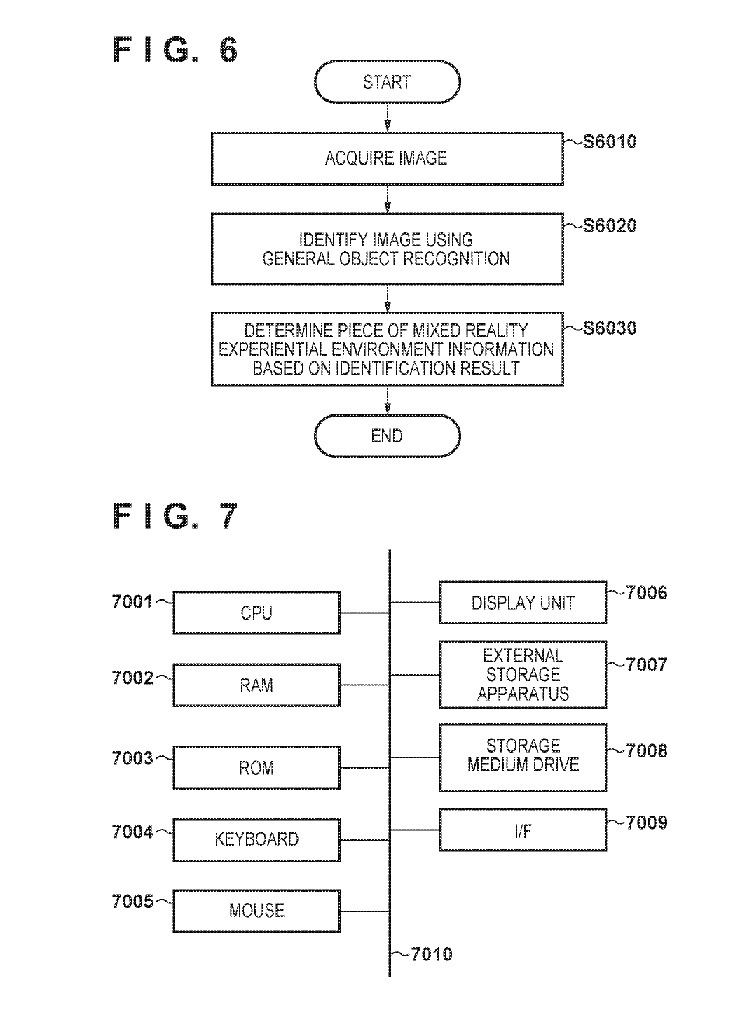

FIG. 6 is a flowchart showing processing procedures according to the present embodiment by which a piece of mixed reality experiential environment information is determined. In step S6010, the image acquisition unit 1050 acquires an image from the camera 200. In step S6020, the general object recognition unit 1060 extracts features from the acquired image, and checks the features against a database held by a general object information holding unit, which is not shown in the drawings, and outputs the result of object identification to the environment information determination unit 1070. Any known general object recognition technology may be adopted.

In step S6020, the environment information determination unit 1070 determines a piece of category information regarding the location, based on the result of object identification by the general object recognition unit 1060, and determines the piece of category information as a piece of mixed reality experiential environment information. Here, for example, if the general object recognition unit 1060 recognizes an object as a whiteboard, the category of the location, which is a piece of mixed reality experiential environment information, is determined as “meeting room”.

In this way, typical objects, which are likely to exist at the location, have been preliminarily classified into category locations, and a piece of category information is added to the object identified by general object recognition, and the piece of category information is output to the environment information determination unit 1070 as a piece of mixed reality experiential environment information. The environment information acquisition unit 1010 acquires the piece of mixed reality experiential environment information, which has been determined by the environment information determination unit 1070.

As described above, according to the present embodiment, a piece of mixed reality experiential environment information is determined based on general object recognition. Then, a piece of feature information, which has been determined in the same manner as in the first embodiment, is presented by the information presentation apparatus 100. For example, the piece of feature information is projected to the environment in which mixed reality is to be experienced, by using a projector or the like. Instead of using a projector, any method may be adopted insofar as the piece of feature information can be presented.

The position and orientation estimation unit 1080 acquires a captured image of the presented feature pattern, detects natural features based on the image, and estimates the position and the orientation of the camera 200 based on a known method for estimating the position and the orientation of a camera.

As described above, it is possible to determine a piece of feature information corresponding to a piece of mixed reality experiential environment information, as a feature object. When estimating the position and the orientation of the camera based on natural features, it is possible to reliably detect natural features. Therefore, it is possible to produce a stable mixed reality. Also, it is possible to produce a strong sense of immersion because a feature object that is familiar to the user and that does not seem out of place is placed in the location in which mixed reality is to be experienced.

### Third Embodiment

In the first embodiment, a description was given of an example in which the user determines a piece of mixed reality experiential environment information by selecting the piece of mixed reality experiential environment information from a list of pieces of mixed reality experiential environment information, which is displayed on a GUI, by using a mouse. In the second embodiment, a description was given of an example in which a piece of mixed reality experiential environment information is acquired by identifying the environment in which mixed reality is to be experienced, based on an object detected from a captured image as a result of object recognition. In contrast, in the present embodiment, a description is given of an example in which a piece of feature information is determined by, when determining a piece of feature information, allowing the user to select a piece of feature information that it to be used for feature detection from among one or more pieces of feature information, without acquiring a piece of experiential environment information.

FIG. 8 is a diagram showing an example of a configuration of an information processing apparatus 5000 according to a third embodiment. The information processing apparatus 5000 includes an information holding unit 5010, a data management unit 5020, an information presentation unit 5030, an input receiving unit 5050, an information determination unit 5060, and an information output unit 5070. The information processing apparatus 5000 is connected to an information output apparatus 500 and an input apparatus 5040.

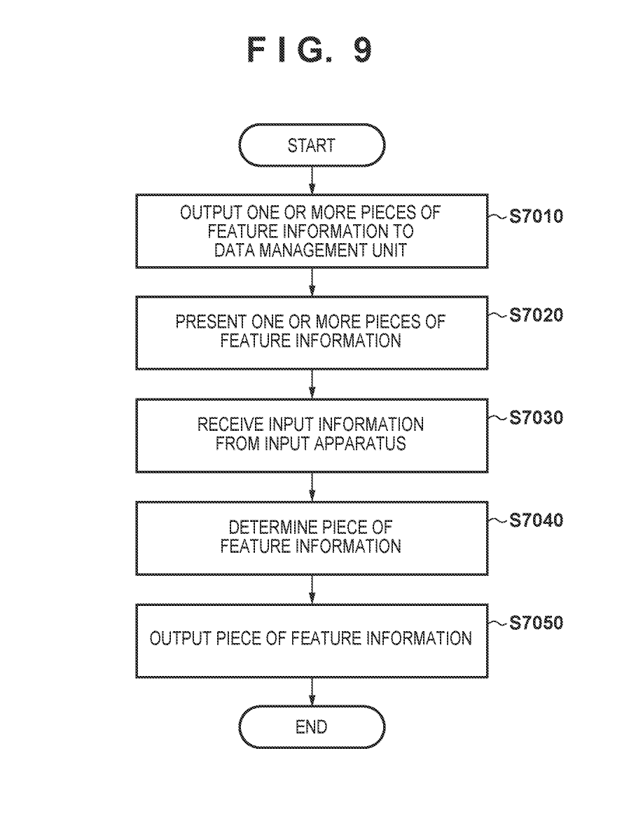

FIG. 9 is a flowchart showing processing procedures according to the present embodiment by which, in order to provide a mixed reality experience, a piece of feature information, which has been detected by using feature detection from an image captured by an image capturing apparatus attached to an HMD, is output in response to selection by the user.

In step S7010, the information holding unit 5010 outputs one or more pieces of feature information to the data management unit 5020.

In step S7020, the data management unit 5020 outputs one or more pieces of feature information to the information presentation unit 5030, and the information presentation unit 5030 presents one or more pieces of feature information.

In step S7030, the user checks the one or more pieces of feature information presented by the information presentation unit 5030, and selects a piece of feature information. The user selects a piece of feature information by inputting input information, using the input apparatus 5040, which is a mouse, a keyboard, a touch panel, or the like, and the input receiving unit 5050 receives the input information.

In step S7040, the information determination unit 5060 determines a piece of feature information based on the input information received by the input receiving unit 5050.

In step S7050, the information output unit 5070 outputs the piece of feature information determined by the information determination unit 5060 to the information output apparatus 500, which is a display or the like. The information output apparatus 500 is not limited to a display, and may be a projector or a printer insofar as a piece of feature information can be output.

As described above, according to the present embodiment, a piece of mixed reality feature information regarding mixed reality can be determined by the user selecting an appropriate piece of feature information from among pieces of feature information. Consequently, when estimating the position and the orientation of the camera based on natural features, it is possible to reliably detect natural features. Therefore, it is possible to provide a stable mixed reality. Also, it is possible to produce a strong sense of immersion because a feature object that is familiar to the user and that does not seems out of place is placed in the location in which mixed reality is to be experienced.

Modification

According to the above-described first to third embodiments, it is possible to output a feature pattern that is suited to the environment in which MR is to be experienced. In contrast, according to the present modification, arrangement information (position information) that indicates the position in the physical space where the determined feature pattern should be placed is also output.

Specifically, features are extracted from an image of a physical space captured by an image capturing apparatus. The features to be extracted are features detected by a known technique such as scale-invariant feature transform (SIFT) or features from accelerated segment test (FAST). Next, the distribution of extracted features within the image is evaluated. For example, the image is divided into blocks, and for each of the divisional blocks, it is determined whether or not extracted features are contained therein. Then, control is performed such that features are widely distributed within blocks that have been determined as not containing a feature, i.e., such that the extracted features are included therein. For example, if a white wall of a room is shown in an end area of an image, it will be determined that the area does not contain a feature. According to the present modification, the distribution of features is evaluated using the above-described method, and thus the arrangement information (position information) regarding the features is also output so that the features are widely distributed.

According to the present modification, it is possible to allow even users who do not have the know-how or knowledge about the arrangement of features to place an appropriate pattern at an appropriate position.

### Fourth Embodiment

Each of the units included in the information processing apparatuses 1000, 3000, and 5000 may be configured with hardware or software. A computer implemented as hardware is caused to execute this software, and thus the computer performs the operations of the information processing apparatuses described in the embodiments above.

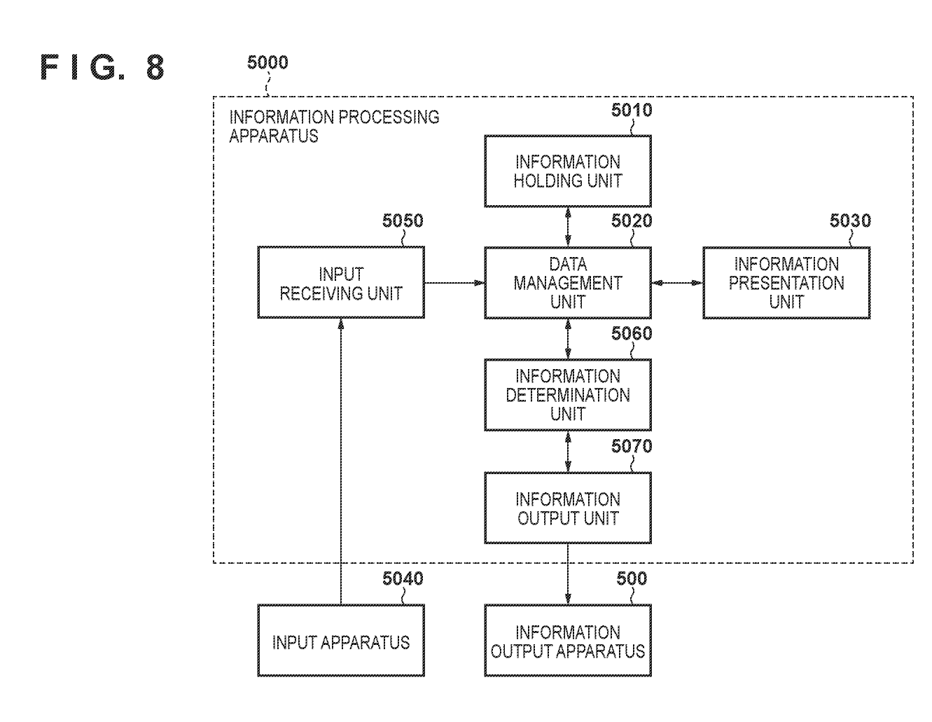

FIG. 7 is a block diagram showing an example of a hardware configuration according to the present embodiment. A CPU 7001 controls the entire computer by using programs and data stored in a RAM 7002 and a ROM 7003, and also performs each of the processing procedures that have been described in the embodiments above as processing procedures performed by an information processing apparatus.

The RAM 7002 includes an area for temporarily storing programs and data loaded from an external storage apparatus 7007 or a storage medium drive 7008. The RAM 7002 also has an area for temporarily storing data received from an external apparatus via an interface (I/F) 7009. Here, “external apparatus” means the camera 200, for example. The RAM 7002 also has a work area that is used when the CPU 7001 executes various kinds of processing. In other words, the RAM 7002 provides various kinds of areas as appropriate.

The ROM 7003 stores setting data, boot programs, and so on for the computer. A keyboard 7004 and a mouse 7005 are examples of operation input apparatuses, and input various kinds of instructions to the CPU 7001 upon being operated by the user. A display unit 7006 is configured with a display, and is capable of displaying processing results based on display control performed by the CPU 7001, as images, characters, and the like.

The external storage apparatus 7007 is a large-capacity information storage apparatus such as a hard disk drive apparatus. The external storage apparatus 7007 stores an operation system (OS), and programs and data for allowing the CPU 7001 to execute the processing procedures that have been described above as processing procedures that are to be executed by the information processing apparatus. The programs include programs respectively corresponding to the units included in the information processing apparatus.

The data includes virtual object model data and data that has been described above as known information. The programs and data stored in the external storage apparatus 7007 are loaded to the RAM 7002 as appropriate according to control performed by the CPU 7001. The CPU 7001 executes the programs and data thus loaded, thereby executing the processing procedures that have been described above as processing procedures that are to be executed by the information processing apparatus.

The storage medium drive 7008 reads out the programs and the data stored in a storage medium such as a CD-ROM or a DVD-ROM, and writes programs and data onto such a storage medium. Note that all or part of the programs and the data that have been described above as programs and data stored in the external storage apparatus 7007 may be stored in this storage medium. The programs and data read out from the storage medium by the storage medium drive 7008 are output to the external storage apparatus 7007 or the RAM 7002.

The I/F 7009 is configured with an analogue video port or a digital input/output port such as an IEEE 1394 port, for connection with the camera 200, a DVI port for outputting a composite image to the information presentation apparatus 100, and so on. Data received via the I/F 7009 is input to the RAM 7002 or the external storage apparatus 7007. Note that some of the functions of the image acquisition unit 1050 shown in FIG. 5 are realized with the I/F 7009. A reference numeral 7010 indicates a bus that connects the above-described units.

As described above, the present invention is capable of providing feature information that is suited to the environment in which mixed reality is to be experienced when the position and the orientation of the camera is estimated based on natural features. Therefore, it is unnecessary for the user to know beforehand what natural features are suitable for estimating the position and the orientation of the camera. In other words, it is unnecessary for the user to learn background knowledge before experiencing mixed reality. Therefore, the burden on the user is reduced, and it is easy to provide the user with a mixed reality experience.

Also, since pieces of feature information corresponding to natural features that are used with the method for estimating the position and the orientation of the camera can be stored in advance, it is possible to determine a piece of feature information that can be used for reliably detecting natural features.

According to one aspect of the present invention, it is possible to provide information regarding natural features that are suitable for estimating the position and the orientation of a camera.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-177917, filed Sep. 9, 2015, Japanese Patent Application No. 2016-106717, filed May 27, 2016, which are hereby incorporated by reference wherein in their entirety.

What is claimed is:

1. An information processing apparatus for determining feature information that is to be used to estimate a position and an orientation of a camera, the information processing apparatus comprising:
a holding unit configured to hold environment information regarding a physical space, and feature information corresponding to the environment information regarding the physical space, in association with each other;
an acquisition unit configured to acquire environment information regarding a physical space in which mixed reality is to be experienced; and
a determination unit configured to determine feature information that is to be placed in the physical space in which mixed reality is to be experienced, based on the environment information acquired by the acquisition unit.

2. The information processing apparatus according to claim 1,
wherein the determination unit is further configured to determine position information regarding where the feature information is to be placed.

3. The information processing apparatus according to claim 1,
wherein the environment information is category information regarding a location in which the mixed reality is to be experienced.

4. The information processing apparatus according to claim 3,
wherein the category information regarding a location indicates a meeting room, a construction site, or a factory.

5. The information processing apparatus according to claim 1,
wherein the environment information is information regarding a type of a natural feature.

6. The information processing apparatus according to claim 5,
wherein the information regarding a type of a natural feature indicates a salient point, an edge, or a luminance gradient.

7. The information processing apparatus according to claim 1, further comprising:
a selection unit configured to select the environment information according to a user operation.

8. The information processing apparatus according to claim 1, further comprising:
an information setting unit configured to set images that have been found from the Internet by a search based on the environment information, as the feature information,
wherein the information holding unit is further configured to hold the environment information, and the feature information that has been set by the information setting unit, in association with each other.

9. The information processing apparatus according to claim 1, further comprising:
an image acquisition unit configured to acquire an image;
an object recognition unit configured to recognize an object based on the acquired image; and
an environment information determination unit configured to determine the environment information based on the recognized object.

10. The information processing apparatus according to claim 9, further comprising:
an estimation unit configured to detect a feature from the image acquired by the image acquisition unit, and estimate the position and the orientation of the camera based on the detected feature.

11. The information processing apparatus according to claim 10, further comprising:
an information presentation unit configured to present the feature information determined by the environment information determination unit.

12. The information processing apparatus according to claim 11,
wherein the information presentation unit is further configured to project the feature information determined by the environment information determination unit.

13. An information processing apparatus for determining a piece of feature information that is to be used to estimate a position and an orientation of a camera, the information processing apparatus comprising:
a holding unit configured to hold pieces of feature information;
a display control unit configured to cause a display unit to display the pieces of feature information;
a selection unit configured to select at least one piece of feature information based on a user instruction, from among the pieces of feature information displayed by the display unit; and
an output unit configured to output the piece of feature information thus selected.

14. The information processing apparatus according to claim 13,
wherein the pieces of feature information are pieces of image information having feature patterns.

15. The information processing apparatus according to claim 13,
wherein the pieces of feature information are pieces of three-dimensional model information.

16. The information processing apparatus according to claim 13,
wherein the pieces of feature information are pieces of object name information.

17. A method for controlling an information processing apparatus, the information processing apparatus being for determining feature information that is to be used to estimate a position and an orientation of a camera, and including a holding unit configured to hold environment information regarding a physical space, and feature information corresponding to the environment information regarding the physical space, in association with each other, the method comprising:
acquiring environment information regarding a physical space in which mixed reality is to be experienced; and
determining feature information that is to be placed in the physical space in which mixed reality is to be experienced, based on the acquired environment information.

18. A method for controlling an information processing apparatus, the information processing apparatus being for determining a piece of feature information that is to be used to estimate a position and an orientation of a camera, and including a holding unit configured to hold pieces of feature information, the method comprising:
causing a display unit to display the pieces of feature information;
selecting at least one piece of feature information based on a user instruction, from among the pieces of feature information displayed by the display unit; and
outputting the piece of feature information thus selected.

19. A non-transitory computer-readable storage medium storing a computer program for causing a computer to execute a method for controlling an information processing apparatus, the information processing apparatus being for determining feature information that is to be used to estimate a position and an orientation of a camera, and including a holding unit configured to hold environment information regarding a physical space, and feature information corresponding to the environment information regarding the physical space, in association with each other, the method comprising:
acquiring environment information regarding a physical space in which mixed reality is to be experienced; and
determining feature information that is to be placed in the physical space in which mixed reality is to be experienced, based on the piece of environment information thus acquired.

20. A non-transitory computer-readable storage medium storing a computer program for causing a computer to execute a method for controlling an information processing apparatus, the information processing apparatus being for determining a piece of feature information that is to be used to estimate a position and an orientation of a camera, and including a holding unit configured to hold pieces of feature information, the method comprising:
causing a display unit to display the pieces of feature information;
selecting at least one piece of feature information based on a user instruction, from among the pieces of feature information displayed by the display unit; and
outputting the piece of feature information thus selected.
